(19) United States
(12) Patent Application Publication
(10) Pub. No.: US 2026/0220573 A1
(43) Pub. Date: Jul. 30, 2026

(54) A SYSTEM AND A METHOD FOR REAL-TIME TASK MANAGEMENT AND CONTEXT SWITCHING

(71) Applicant: Amol Mohan BHORE, Pune (IN)

(72) Inventor: Amol Mohan BHORE, Pune (IN)

(21) Appl. No.: 19/133,807

(22) PCT Filed: Oct. 30, 2023
(86) PCT No.: PCT/IB2023/060895

§ 371 Date: May 29, 2025

(30) Foreign Application Priority Data
Nov. 29, 2022 (IN) 202221068725

(51) Int. Cl. G06Q 10/0631

(52) U.S. Cl. CPC G06Q 10/06316

(57) ABSTRACT

The present disclosure discloses a system (100) and a method (200) for real-time task management and context switching. The system (100) comprises a server (102) implementing an application platform having framework (102a), repository (102b), a user interface (104) receiving task request including task definition, time required to execute, input and output parameters; a master interface (106) define workflow based on received task request; a scheduling module (108) execute robot task scheduling, a task scheduler unit (110) create a trigger for defined workflow with time, priority, timeout, repeat count and schedule task in a queue based on created trigger; a queue manager (112) manage queue by retrieving task based on priority selected during trigger creation, sorting task by scheduled date time, available robots with their workflow assignments; a farm manager unit (114) retrieves task and makes available robots and assign task to available robots; a state manager unit (116) identify robot status of available robots for further task assignments and storing robot status.

### FIELD OF INVENTION

The present disclosure generally relates to the field of task management system and context switching system. More particularly, the present disclosure relates to a system and a method for real-time task management and context switching.

### Definitions

As used in the present disclosure, the following terms are generally intended to have the meaning as set forth below, except to the extent that the context in which they are used to indicate otherwise.

Job/Task: The term ‘job/task’ hereinafter refers to a job/task or operation that needs to be executed by a machine, a processor, an electronic component, software robot or a robotic machine. The job/task is executed as per the workflow assigned to the robot.

Workflow: The term ‘workflow’ hereinafter refers to a flowchart or set of instructions with sequence/order which will be executed by a robotic machine or software robot to complete an intended task or job.

Job/Task Scheduler: The term ‘job/task schedule’ hereinafter refers to a detailed description of the execution date and time, priority, workflow, timeout, and repeat count of the scheduled task. The scheduled task is executed by robot based on the scheduling parameter.

Queue: The term ‘queue’ hereinafter refers to a sequence of task execution by a robotic machine. The queue is a collection of job/task which are maintained as executed in a sequence and It worked as a first-in-first-out, where new job/task is added in a queue at one end and removed from the another end after completion of job/task.

Queue Manager: The term ‘queue manager’ hereinafter refers to managing the queue, adding and retrieving every task based on parameters such as execution date, time and priority.

Robot Farm Manager: The term ‘robot farm manager’ hereinafter refers to an electronic controller that initializes a robot across a robot farm and makes the robots in the robot farm ready to execute any task.

Robot State Manager: The term ‘robot state manager’ hereinafter refers to an electronic controller that manages a robot's state and context that optimally utilizes the robot and robot's states including available or busy.

Cron: The term ‘cron’ hereinafter refers to a command to an operating system or a server for a job/task that is to be executed at a specified time.

### BACKGROUND

The background information herein below relates to the present disclosure but is not necessarily prior art.

Conventionally, the existing system uses a robot scheduling method for handling a single task/use case type that is serialized in nature, and hence robot can execute a single task at a time and update the task after completion of an assigned task, The individual robot is assigned a task and executed it accordingly and hence it is a time-consuming process and it postponed the workflow, The existing system does not provide the context switching operation, where the robots can handle different types of tasks/use cases simultaneously, Also robot does not assign with multiple tasks and not able to execute the multiple tasks.

This makes robots tightly bound to a given type of automation task and this reduces proper utilization of robot infrastructure and unnecessary increases in robot count to serve all types of tasks/use cases.

The existing system does not take into consideration of underlying system's Processing Power (CPU, Memory) before selecting the right Robot for a job/task. Further, the existing system does not maintain a state of the Robot nor it takes it into consideration for selecting a Robot for a job/task.

The existing system does not improve the utilization because of single task/use case type handling, Hence, the robot state is constant till the completion of a task, and then the new task is assigned to the robot.

Thus, there is necessary to determine the task scheduling for the robot, that can handle and execute context switching to optimize time consumption and use optimum hardware.

Therefore, it is felt a need for a system and a method for real-time task management and context switching.

### Objects

Some of the objects of the present disclosure, which at least one embodiment herein satisfies, are as follows:

An object of the present disclosure is to provide a system for real-time task management and context switching.

Another object of the present disclosure is to provide a mechanism for task assignments.

Yet another object of the present disclosure is to provide a mechanism for assigning a task to the available robots based on their work assignments.

Still another object of the present disclosure is to provide a mechanism for scheduling tasks in a queue.

Yet another object of the present disclosure is to provide a mechanism for context switching to reduce the overall time consumption.

Still another object of the present disclosure is to provide a method for real-time task management and context switching.

Other objects and advantages of the present disclosure will be more apparent from the following description, which is not intended to limit the scope of the present disclosure.

### SUMMARY

The present disclosure envisages a system for real-time task management and context switching. The system includes a server.

The server is implementing a platform having a framework and a repository, wherein the framework includes a robot profile, trigger details, workflow, and test parameters.

The server includes a user interface, a master interface, and a scheduling module.

The user interface is configured to receive a task request from a client application running on a computing device of a registered user, wherein the task request includes task definition, a time required to execute the task request, input parameters, and output parameters.

The master interface is configured to define a workflow based on the received task request.

The scheduling module is configured to execute robot task scheduling.

The scheduling module comprises a task scheduler unit, a queue manager, a farm manager unit, and a state manager unit.

The task scheduler unit is configured to create a trigger for the defined workflow with time, priority, timeout, and repeat count, and further is configured to schedule at least one task in a queue based on the created trigger.

The queue manager unit in communication with the task scheduler unit to manage the queue by retrieving the task based on the priority selected during trigger creation, sorting the task by scheduled date and time, and available robots with their workflow assignments

The farm manager unit is configured to communicate with the queue manager unit to retrieve each task and makes the available robots across the robot farm context ready, and further is configured to assign the task to at least one of the available robots based on their work assignments.

The state manager unit is configured to communicate with the farm manager unit to identify a robot status of the available robots for further task assignments and store the robot status in the repository.

The task scheduler unit, the queue manager, the farm manager unit, and the state manager unit are executed by one or more microprocessors.

In an aspect, the repository is configured to store task parameters, job schedules, details of robot farm, a set of rules, and predefined parameters.

In an aspect, the robot status includes a busy status for a robot till that robot completes the assigned task.

In an aspect, the robot status includes an available status once a robot completes the assigned task.

In an aspect, the application platform is consisting of a web-based platform, a service-based platform, a cloud-based platform, and a mobile-based platform.

In an aspect, the user interface permits access and permission under the different rights of the registered user and the registered user having rights to configure the job/task in the scheduler.

In an aspect, the master interface consisting of a user profile with details, user's role, user's permission, user's access, and user's rights permitted.

In an aspect, the robot updates a task completion status, including successful or failed, in the repository of the system, so that the system makes the robot available for a further task assignment.

In an aspect, the farm manager unit consists of MacId, CPU, and memory of all the robots available in the robot farm.

In an aspect, the task consists of task id, start time, end time, workflow to execute, input, output, and execution status.

In an aspect, the scheduling module includes a scheduler, cron, queue, and available robot with their capability and workflow assignments.

In an aspect, the Robotic Process Automation (RPA) simplifies the development, deployment, and management of software robots which mimic human activity in digital systems and applications.

In an aspect, during runtime, context-switching can be applied to existing idle Robots so that they can begin working on any use case without any or little downtime and without context-switching. This improves the utilization of existing Robot infrastructure and licenses.

The present disclosure further envisages a method for real-time task management and context switching. The method is being carried out by a server implementing an application platform having a framework and a repository, wherein the framework includes a robot profile, trigger details, workflow, and test parameters. The method comprises the following steps:
receiving, by a user interface of the server, a task requests from a client application running on a computing device of a registered user, wherein the task request includes task definition, a time required to execute the task request, input parameters, and output parameters;
defining, by a master interface of the server, a workflow based on the received task request;
creating, by a task scheduler unit of the server, a trigger for the defined workflow with time, priority, timeout, and repeat count;
scheduling, by the task scheduler unit, at least one task in a queue based on the created trigger;
managing, by a queue manager unit of the server, the queue by retrieving the task based on the priority selected during trigger creation, sorting of the task by scheduled date and time, and available robots with their workflow assignments;
retrieving, by a farm manager unit of the server, each the task to make the available robots across the robot farm context ready;
assigning, by the farm manager unit, the task to at least one of the available robots based on their work assignments; and
identifying, by a state manager unit of the server, the robot status of the available robots for further task assignments and storing the robot status in the repository.

### BRIEF DESCRIPTION OF THE ACCOMPANYING DRAWING

A system and a method for real-time task management and context switching of the present disclosure will now be described with the help of the accompanying drawing, in which:

FIG. 1 illustrates a block diagram of a system for real-time task management and context switching, in accordance with an embodiment of the present disclosure;

FIG. 2A and FIG. 2B illustrate a flow diagram for real-time task management and context switching, in accordance with an embodiment of the present disclosure; and

FIG. 3 illustrates a block diagram of an architecture for real-time task management and context switching, in accordance with an embodiment of the present disclosure.

FIG. 4 illustrates a sequence diagram for real-time task management and context switching, in accordance with an embodiment of the present disclosure.

### LIST OF REFERENCE NUMERALS

100—System
102—Server
102a—Framework
102b—Repository
104—User Interface
106—Master Interface
108—Scheduling Module
110—Task Scheduler Unit
112—Queue Manager
114—Farm Manager Unit
116—State Manager Unit

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “including,” and “having,” are open-ended transitional phrases and therefore specify the presence of stated features, integers, steps, operations, elements, and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “engaged to,” “connected to,” or “coupled to” another element, it may be directly engaged, connected or coupled to the other element. As used herein, the term “and/or” includes any and all combinations of one or more of the associated listed elements.

In an existing robot scheduling system, a single robot is assigned to a single task/use case type and can't do the context switching to handle different types of tasks/use cases unless the robot is restarted. This makes robots tightly bound to a given type of automation task and this reduces proper utilization of robot infrastructure and unnecessary increases in robot count to serve all types of tasks/use cases.

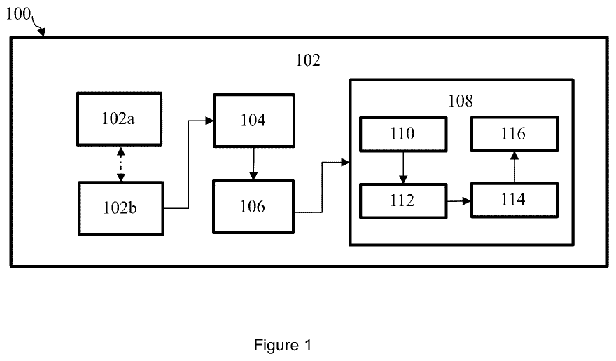

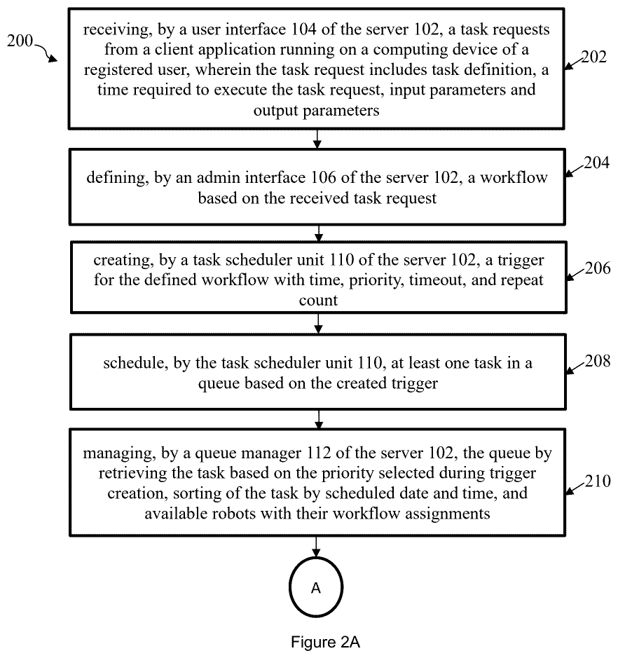

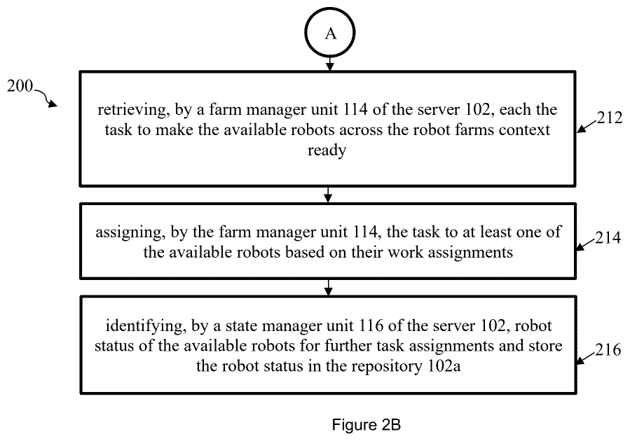

To overcome the above-mentioned problems, the present disclosure proposes a system (hereinafter referred to as “system 100”) and a method (hereinafter referred to as “method 200”) for real-time task management and context switching. The system 100 and method 200 are now being described with reference to FIG. 1 and FIG. 2A and FIG. 2B.

Referring to FIG. 1, the system 100 comprises a server 102.

The server 102 is implementing an application platform having a framework 102a and a repository 102b, wherein the framework includes a robot profile, trigger details, workflow, and test parameters.

The server 102 includes a user interface 104, a master interface 106, and a scheduling module 108.

The user interface 104 is configured to receive a task request from a client application running on a computing device of a registered user, wherein the task request includes task definition, a time required to execute the task request, input parameters, and output parameters.

The master interface 106 is configured to define a workflow based on the received task request.

The scheduling module 108 is configured to execute robot task scheduling.

The scheduling module 108 comprises a task scheduler unit 110, a queue manager unit 112, a farm manager unit 114, and a state manager unit 116.

The task scheduler unit 110 is configured to create a trigger for the defined workflow with time, priority, timeout, and repeat count, and is further configured to schedule at least one task in a queue based on the created trigger.

The queue manager unit 112 is in communication with the task scheduler unit to manage the queue by retrieving the task based on the priority selected during trigger creation, sorting of the task by scheduled date and time, and available robots with their workflow assignments.

The farm manager unit 114 is configured to communicate with the queue manager unit to retrieve each task and makes the available robots across the robot farm context ready, and further configured to assign the task to at least one of the available robots based on their work assignments.

The state manager unit 116 is configured to communicate with the farm manager unit 114 to identify the robot status of the available robots for further task assignments and store the robot status in the repository 102b.

The task scheduler unit 110, the queue manager unit 112, the farm manager unit 114, and the state manager unit 116 is executed by one or more microprocessors.

In an aspect, the repository is configured to store task parameters, task schedule, details of robot farm, a set of rules, and predefined parameters.

In an aspect, the robot status includes a busy status for a robot till that robot completes the assigned task.

In an aspect, the robot status includes an available status once a robot completes the assigned task.

In an aspect, the application platform is consisting of a web-based, service-based, cloud-based, and mobile-based platform.

In an aspect, the user interface 104 permits access and permission under the different rights of the registered user and the registered user having rights to configure the job/task in the scheduler.

In an aspect, the master interface 106 is consisting of a user profile with details, user's role, permission, access, and rights permitted.

In an aspect, the robot updates a task completion status, including successful or failed, in the repository 102b of the system 100, so that the system makes the robot available for the further task assignment.

In an aspect, the farm manager unit 114 consists of MacId, CPU, and memory of all the robots available in the robot farm.

In an aspect, the task consists of task id, start time, end time, workflow to execute, input, output, and execution status.

In an aspect, the scheduling module 108 includes a scheduler, cron, queue, and available robot with their capability and workflow assignments.

In an aspect, the real-time task management is a robot task scheduling.

In an aspect, the Robotic Process Automation (RPA) simplifies the development, deployment, and management of software robots which mimic human activity in digital systems and applications.

In an aspect, during runtime, context-switching can be applied to existing idle Robots so that they can begin working on any use case without any or little downtime and without context-switching. This improves the utilization of existing Robot infrastructure and licenses.

In an aspect, the system is real-time task management and context switching robot process automation.

In an aspect, TABLE I discloses the entities and their attributes used in the system 100.

TABLE I
Entities and attributes of the system

| Entities | Attributes |
|---|---|
| Robot Farm System | MacId, CPU, Memory |
| Robot | Workflow Assignments |
| Workflow | Definition, Time required to execute, inputs, outputs |
| Trigger | Priority, Scheduled Date and Time, Timeout, Repeat |
| | Count |
| Job/ Task | Job/Task Id, Start Time, EndTime, WorkflowTo |
| | Execute, Input, Output, Execution Status |
| Scheduling System | Scheduler, Cron, Queue, Available Robot with their |
| | Capability and Workflow Assignments |

In an aspect, TABLE II discloses the test data consists of workflow, robot farm, trigger, queue, robot task execution.

TABLE II
Workflow of the task with definition and its execution time

| | | ExecutionTime |
|---|---|---|
| Name | Definition | (in Secs) |
| Workflow1 | PO Processing | 20 |
| Workflow2 | Quotation Generation | 10 |
| Workflow3 | Account Update | 20 |
| Workflow4 | Attendance Processing | 30 |

In an aspect, TABLE III discloses the list of robot name with their CPU time, Memory, their individual MacId and assigned workflow assignments.

TABLE III
Configuration of different robots with workflow assignments

| | CPU (in | Memory | | Workflow |
|---|---|---|---|---|
| Robotname | Cores) | (in GB) | MacId | Assignments |
| Robot1 | 1 | 4 | 5A-CC-C6-79-99-18 | Workflow1, |
| | | | | Workflow3 |
| Robot2 | 1 | 4 | 86-4C-10-73-80-62 | Workflow2, |
| | | | | Workflow4 |
| Robot3 | 2 | 8 | 33-1C-DA-A8-BE-DC | Workflow1, |
| | | | | Workflow4 |

In an aspect, TABLE IV discloses the trigger events with priority with respect to workflow and repeat count.

TABLE IV
Trigger events with priority with respect
to workflow and repeat count

| | | | | Repeat |
|---|---|---|---|---|
| Name | Date Time | Priority | Workflow | Count |
| Trigger1 | 07-30-2022T16:30 | High | Workflow1 | 3 |
| Trigger2 | 07-30-2022T16:30 | Medium | Workflow2 | 5 |
| Trigger3 | 07-30-2022T16:30 | Low | Workflow3 | 2 |
| Trigger4 | 07-30-2022T16:30 | Medium | Workflow4 | 2 |

In an aspect, TABLE V discloses the execution time required for the assigned workflow with priority.

TABLE V
Trigger queue with priority and execution time

| | Trigger | | | | Exe Time |
|---|---|---|---|---|---|
| Id | Name | Date time | Priority | Workflow | in Secs |
| 1 | Trigger1 | 07-30-2022T16:30 | High | Workflow1 | 20 |
| 2 | Trigger1 | 07-30-2022T16:30 | High | Workflow1 | 20 |
| 3 | Trigger1 | 07-30-2022T16:30 | High | Workflow1 | 20 |
| 4 | Trigger2 | 07-30-2022T16:30 | Medium | Workflow2 | 10 |
| 5 | Trigger2 | 07-30-2022T16:30 | Medium | Workflow2 | 10 |
| 6 | Trigger2 | 07-30-2022T16:30 | Medium | Workflow2 | 10 |
| 7 | Trigger2 | 07-30-2022T16:30 | Medium | Workflow2 | 10 |
| 8 | Trigger2 | 07-30-2022T16:30 | Medium | Workflow2 | 10 |
| 9 | Trigger3 | 07-30-2022T16:30 | Low | Workflow3 | 20 |
| 10 | Trigger3 | 07-30-2022T16:30 | Low | Workflow3 | 20 |
| 11 | Trigger4 | 07-30-2022T16:30 | Medium | Workflow4 | 30 |
| 12 | Trigger4 | 07-30-2022T16:30 | Medium | Workflow4 | 30 |

In an aspect, the TABLE VI discloses the robot task execution with taskID and execution date and time required for the robot.

TABLE VI
Robot task Execution

| | Job/task | | Exe Time |
|---|---|---|---|
| Robot | Id | Exe DateTime | in Secs |
| Robot1 | 1 | 07-30-2022T16:30:00 | 20 |
| Robot2 | 4 | 07-30-2022T16:30:00 | 10 |
| Robot3 | 2 | 07-30-2022T16:30:00 | 20 |
| Robot1 | 3 | 07-30-2022T16:30:20 | 20 |
| Robot2 | 5 | 07-30-2022T16:30:10 | 10 |
| Robot2 | 6 | 07-30-2022T16:30:20 | 10 |
| Robot2 | 7 | 07-30-2022T16:31:30 | 10 |
| Robot2 | 8 | 07-30-2022T16:31:40 | 10 |
| Robot1 | 9 | 07-30-2022T16:30:40 | 20 |
| Robot1 | 10 | 07-30-2022T16:31:00 | 20 |
| Robot3 | 11 | 07-30-2022T16:30:20 | 30 |
| Robot3 | 12 | 07-30-2022T16:30:50 | 30 |

In an aspect, the TABLE VII discloses the Final Result with total time required to execute task.

TABLE VII
Final Result with total time required to execute task

| Final Result | Required Time |
|---|---|
| Total Time Required To Execute (in | 210 |
| Secs) | |
| Without scheduling completion | 07-30-2022T16:33:30 |
| DateTime | |
| With scheduler completion datetime | 07-30-2022T16:31:50 |
| Saving of compute time (in Secs) | 100 |

In an aspect, the TABLE VIII discloses the test parameters for evaluating the performance of test data.

TABLE VIII
Performance Test Data

| Test Parameter | Value | Unit |
|---|---|---|
| No. of Robots | 50 | number |
| Workflow Execution Time per request | 3 | seconds |
| Workflow Execution Time per request | 5 | seconds |
| with Delays | | |
| No. of Workflow Requests | 10092 | number |
| Expected Total Time | 50460 | seconds |
| Execution Start time | 2022-07-27 | datetime |
| | 12:00:43 | |
| Execution Completion time with 50 | 2022-07-27 | datetime |
| Robots | 18:38:21 | |
| Time difference between start and end | 00-01-1900 | time |
| | 06:37 | |
| Time difference between start and end | 22932 | seconds |
| in secs | | |
| Final Avg. execution time per Robot | 2.272294887 | seconds |

Performance data with 80 Robots and 12000 workflow requests

| Test Parameter | Value | Unit |
|---|---|---|
| No. of Robots | 80 | number |
| Workflow Execution Time per request | 120 | seconds |
| Workflow Execution Time per request with | 5 | seconds |
| Delays | | |
| No. of Workflow Requests in Low Priority | 4000 | number |
| Queue | | |
| No. of Workflow Requests in Medium Priority | 4000 | number |
| Queue | | |
| No. of Workflow Requests in High Priority | 4000 | number |
| Queue | | |
| Total No. of Workflow Requests | 12000 | number |
| Expected Total Time without Scheduling | 500000 | seconds |
| and Context Switching Algo for 80 Robots | | |
| Execution Start time | 2022-09-28 | datetime |
| | 07:35:36 | |
| Execution Completion time with 50 Robots | 2022-09-28 | datetime |
| | 17:29:12 | |
| Time difference between start and end | 00-01-1900 | time |
| | 09:53 | |
| Time difference between start and end in secs | 34308 | seconds |
| Final Avg. execution time per Robot | 2.859 | seconds |
| Total Time Saving with Scheduling and | 465692 | seconds |
| Context Switching Algo | | |

FIG. 2A and FIG. 2B illustrate a method 200 for real-time task management and context switching in accordance with an embodiment of the present disclosure. The method 200 is being carried out by a server 102 implementing an application platform having a framework 102a and a repository 102b, wherein the framework 102a includes a robot profile, trigger details, workflow, and test parameter, wherein the method 200 comprising the following steps:

At step 202, the method 200 includes receiving, by a user interface 104 of the server 102, a task requests from a client application running on a computing device of a registered user, wherein the task request includes task definition, a time required to execute the task request, input parameters and output parameters.

At step 204, the method 200 includes defining, by a master interface 106 of the server 102, a workflow based on the received task request.

At step 206, the method 200 includes creating, by a task scheduler unit 110 of the server 102, a trigger for the defined workflow with time, priority, timeout, and repeat count.

At step 208, the method 200 includes scheduling, by the task scheduler unit 110, at least one task in a queue based on the created trigger.

At step 210, the method 200 includes managing, by a queue manager unit 112 of the server 102, the queue by retrieving the task based on the priority selected during trigger creation, sorting of the task by scheduled date and time, and available robots with their workflow assignments.

At step 212, the method 200 includes retrieving, by a farm manager unit 114 of the server 102, each the task to make the available robots across the robot farm context ready.

At step 214, the method 200 includes assigning, by the farm manager unit 114, the task to at least one of the available robots based on their work assignments.

At step 216, the method 200 includes identifying, by a state manager unit 116 of the server 102, the robot status of the available robots for further task assignments and storing the robot status in the repository 102a.

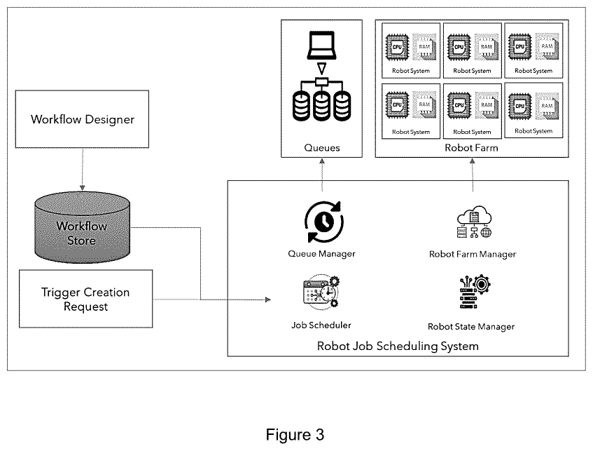

FIG. 3 illustrates a block diagram of an architecture for real-time task management and context switching, in accordance with an embodiment of the present disclosure.

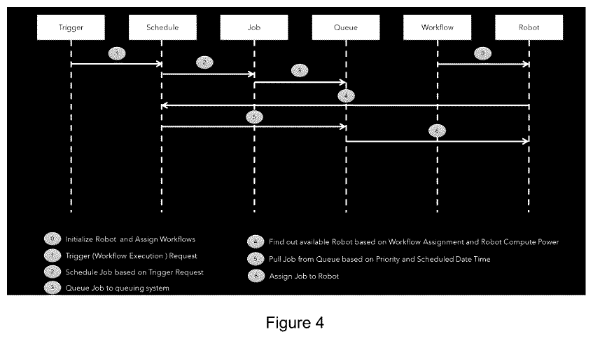

FIG. 4 illustrates a sequence diagram for real-time task management and context switching, in accordance with an embodiment of the present disclosure.

In an operative configuration, the server 102 implements an application platform having a framework 102a and a repository 102b, wherein the framework 102a includes a robot profile, trigger details, workflow, and test parameters. The user interface 104 is configured to receive a task request from a client application running on a computing device of a registered user, wherein the task request includes task definition, a time required to execute the task request, input parameters, and output parameters. The master interface 106 is configured to define a workflow based on the received task request. The scheduling module 108 is configured to execute robot task scheduling. The task scheduler unit 110 is configured to create a trigger for the defined workflow with time, priority, timeout, and repeat count, and further is configured to schedule at least one task in a queue based on the created trigger. The queue manager unit 112 is in communication with the task scheduler unit 110 to manage the queue by retrieving the task based on the priority selected during trigger creation, sorting of the task by scheduled date and time, and available robots with their workflow assignments. The farm manager unit 114 is configured to communicate with the queue manager unit 112 to retrieve each task and makes the available robots across the robot farm context ready, and further is configured to assign the task to at least one of the available robots based on their work assignments. The state manager unit 116 is configured to communicate with the farm manager unit 114 to identify the robot status of the available robots for further task assignments and store the robot status in the repository 102b.

The foregoing description of the embodiments has been provided for purposes of illustration and is not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### TECHNICAL ADVANCEMENTS

The present disclosure described herein above has several technical advantages including, but not limited to, the realization of a system and a method for real-time task management and context switching that:
improve the total utilization,
store robot state during switching of robot context,
serialize and deserialize robot context/state,
optimum hardware utilization, and
reduce time consumption.

The embodiments herein and the various features and advantageous details thereof are explained concerning the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system (100) for real-time task management and context switching, comprising:
a server (102) implementing an application platform having a framework (102a) and a repository (102b), wherein said framework (102a) includes a robot profile, trigger details, workflow details, and test parameters, and wherein the server (102) includes:
a user interface (104) configured to receive a task request from a client application running on a computing device of a registered user, wherein said task request includes task definition, a time required to execute said task request, input parameters, and output parameters;
a master interface (106) configured to define a workflow based on the received said task request; and
a scheduling module (108) configured to execute robot task scheduling, wherein said scheduling module (108) comprises:
a task scheduler unit (110) configured to create a trigger for the defined workflow with time, priority, timeout, and repeat count, and further configured to schedule at least one jo task b in a queue based on the created trigger;
a queue manager unit (112) in communication with said task scheduler unit (110) to manage said queue by retrieving said task based on the priority selected during trigger creation, sorting of the task by scheduled date and time, and available robots with their workflow assignments; and
a farm manager unit (114) configured to communicate with said queue manager unit (112) to retrieve each said task and makes the available robots across the robot farm context ready, and further configured to assign said task to at least one of the available robots based on their work assignments; and
a state manager unit (116) configured to communicate with said farm manager unit (114) to identify robot status of the available robots for further task assignments and storing said robot status in said repository (102b),
wherein said task scheduler unit (110), said queue manager unit (112), said farm manager unit (114), and said state manager unit (116) are executed by one or more microprocessors.

2. The system (100) as claimed in claim 1, wherein said repository (102a) is configured to store task parameters, task schedule, details of robot farm, a set of rules, and predefined parameters.

3. The system (100) as claimed in claim 1, wherein said robot status includes a busy status for a robot till that robot completes the assigned task.

4. The system (100) as claimed in claim 3, wherein said robot status includes an available status once a robot completes the assigned task.

5. The system (100) as claimed in claim 1, wherein said application platform is consisting of a web-based platform, a service-based platform, a cloud-based platform, and a mobile-based platform.

6. The system (100) as claimed in claim 1, wherein said user interface (104) permits access and permission under the different rights of the registered user and the registered user having rights to configure the job/task in the scheduler.

7. The system (100) as claimed in claim 1, wherein said master interface (106) is consisting of a user profile with details, user's role, user's permission, user's access, and user's rights permitted.

8. The system (100) as claimed in claim 1, wherein said robot updates a task completion status, including successful or failed, in the repository (102b) of the system (100), so that the system (100) makes said robot available for the further task assignment.

9. The system (100) as claimed in claim 1, wherein said farm manager unit (114) consists of MacId, CPU, and memory of all the robots available in the robot farm.

10. The system (100) as claimed in claim 1, wherein said task consists of task id, start time, end time, workflow to execute, input, output, and execution status.

11. The system (100) as claimed in claim 1, wherein said scheduling module (108) includes a scheduler, cron, queue, and available robot with their capability and workflow assignments.

12. A method (200) for real-time task management and context switching, wherein the method (200) is being carried out by a server (102) implementing an application platform having a framework (102a) and a repository (102b), wherein the framework (102a) includes a robot profile, trigger details, workflow, and test parameter, wherein the method (200) comprising the following steps:
receiving, by a user interface (104) of said server (102), a task request from a client application running on a computing device of a registered user, wherein said task request includes task definition, a time required to execute said task request, input parameters and output parameters;
defining, by a master interface (106) of said server (102), a workflow based on the received said task request;
creating, by a task scheduler unit (110) of said server (102), a trigger for the defined workflow with time, priority, timeout, and repeat count;
scheduling, by said task scheduler unit (110), at least one task in a queue based on the created trigger;
managing, by a queue manager unit (112) of said server (102), said queue by retrieving said task based on the priority selected during trigger creation, sorting of the task by scheduled date and time, and available robots with their workflow assignments;
retrieving, by a farm manager unit (114) of said server (102), each said task to make the available robots across the robot farm context ready;
assigning, by said farm manager unit (114), said task to at least one of the available robots based on their work assignments;
identifying, by a state manager unit (116) of said server (102), robot status of the available robots for further task assignments and storing said robot status in said repository (102a).
